(19) United States
(12) Patent Application Publication
(10) Pub. No.: US 2018/0085282 A1
(43) Pub. Date: Mar. 29, 2018

(54) Massage Device Having a USB Connector

(71) Applicant: Ting Nan Liu, New Taipei City (TW)

(72) Inventor: Ting Nan Liu, New Taipei City (TW)

(21) Appl. No.: 15/276,552

(22) Filed: Sep. 26, 2016

(51) Int. Cl. A61H 23/02

(52) U.S. Cl. CPC A61H 23/02; A61H 2201/1207; A61H 2201/105; A61H 2201/0111; A61H 2201/5025; A61H 2201/0153

(57) ABSTRACT

A massage device is provided with a container for storing fluid; a vibration assembly including a push button, an axial channel, and a hollow fastening member at an end of the channel; a circuit board electrically connected to the push button and including a through hole; a USB connector electrically connected to the circuit board; a vibration member electrically connected to the circuit board; a receptacle configured to receive the USB connector; a discharge seat including a bossed hole extending downward to put on the channel; an applicator including top projections each having a through hoe, and a multi-channel member on a bottom; a fastening ring; and a cap including a stern, releasably inserted into the fastening member. After removing the cap, the fluid may flow out of the hole members via the opening, the axial channel, the fastening member, and the multi-channel member.

### BACKGROUND OF THE INVENTION

### 1. Field of the Invention

The invention relates to massage devices and more particularly to a massage device having a USB (Universal Serial Bus) connector interconnected to an external power source and a vibration member, in use an activation of the vibration member vibrating fluid applied on the body part, thereby greatly increasing the massaging effect.

### 2. Description of Related Art

A conventional massage device includes a cap, an applicator including a plurality of projections on a top, each projection having a through hole, and a container for storing fluid. In use, after removing the cap a user may incline the container, place the applicator on the body part, and massage the body part by means of the fluid flowing out of the through holes from the container.

However, the hand of the user holding the massage device may be fatigued after a period of time of use, thereby compromising the desired massaging effect.

Thus, the need for improvement still exists.

### SUMMARY OF THE INVENTION

It is therefore one object of the invention to provide a massage device comprising a container having a closed first end and including a space and a joining neck at a second end opposite to the first end, the joining neck communicating with the space and having an opening; a vibration assembly including an annular groove on an underside, a first hole through a cylindrical surface, a second hole through the cylindrical surface and opposite to the first hole, a push button disposed on the first hole, an axial channel having a first end terminated at the annular groove, and a hollow fastening member at a second end of the annular channel; a circuit board electrically connected to the push button and including a through hole; a USB connector electrically connected to the circuit board; a vibration member electrically connected to the circuit board; a receptacle configured to receive the USB connector; a discharge seat including a bossed hole through a center and extending downward to put on the annular channel; an applicator including a plurality of projections on a first surface, and a plurality of holes, each through one of the projections; a fastening ring;

and a cap; wherein the annular groove is put on the joining neck to communicate the axial channel with the opening, the through hole is put on the axial channel, the receptacle is fastened in the second hole, the discharge seat is secured to the vibration-assembly with the bossed hole put on the axial channel, the applicator is put on the discharge seat; the fastening ring is securely put on both an edge of the applicator and an edge of the discharge seat, and the cap is secured to the vibration assembly with the stem inserted into the hollow fastening member.

Preferably, the vibration assembly further comprises a recess adjacent to the axial channel, the discharge seat further comprises a cavity adjacent to the bossed hole, the vibration member is disposed in the recess, and the cavity is secured to the recess to fasten the vibration member.

Preferably, the container further comprises two opposite tabs on the joining neck, the vibration assembly further comprises two troughs on the underside with the tabs fastened in the troughs respectively.

Preferably, further comprises a waterproof, plastic cover mounted on the push button.

Preferably, further comprises a power cord electrically connected to the USB connector.

Preferably, the space is configured to store fluid which is configured to flow to the projections via the opening, the axial channel, and the fastening member, and further flow out of the hole members.

Preferably, the receptacle includes a USB cover.

Preferably, further comprises an interconnection member interconnecting the USB cover and the receptacle.

Preferably, the applicator further comprises a multi-channel member on a second surface opposite to the first surface, the multi-channel member communicating with the hole members.

The invention has the following advantages and benefits in comparison with the conventional art: In addition to applying fluid to the body part and massaging same by the means of the applicator in one operating mode, in the other operating mode the USB connector is required to connect to an external power source prior to activating the vibration member. This can prevent the applicator from being activated by inadvertently pressing the push button. The fastening ring is a leak proof device and in cooperation with inserting the stem into the fastening member, fluid is prevented from leaving the fastening member in an inoperative position. The USB connector can be connected to a portable power supply or the like prior to use. That is, there is no need of finding a suitable outlet or the like prior to use as experienced by a conventional massage device. Finally, no battery is required and thus problems associated with battery recycling, disposal and pollution are eliminated.

The above and other objects, features and advantages of the invention will become apparent from the following detailed description taken with the accompanying drawings.

### BRIEF DESCRIPTION OF THE DRAWINGS

FIG. 1 is a perspective view of a perspective view of a massage device having a USB connector according to the invention;

FIG. 2 is an exploded view of the massage device;

FIG. 2A is a perspective view of the applicator;

FIG. 2B is a broken-away perspective view of the vibration assembly;

FIG. 2C is a perspective view of the discharge seat;

FIG. 3 is a broken-away perspective view of the massage device;

FIG. 4 is a longitudinal sectional view of the massage device; and

FIG. 5 is environmental view of the massage device in a massaging operation.

### DETAILED DESCRIPTION OF THE INVENTION

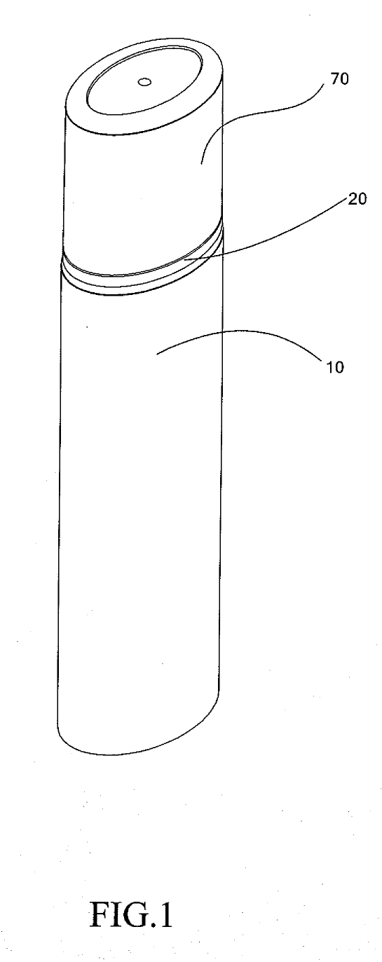

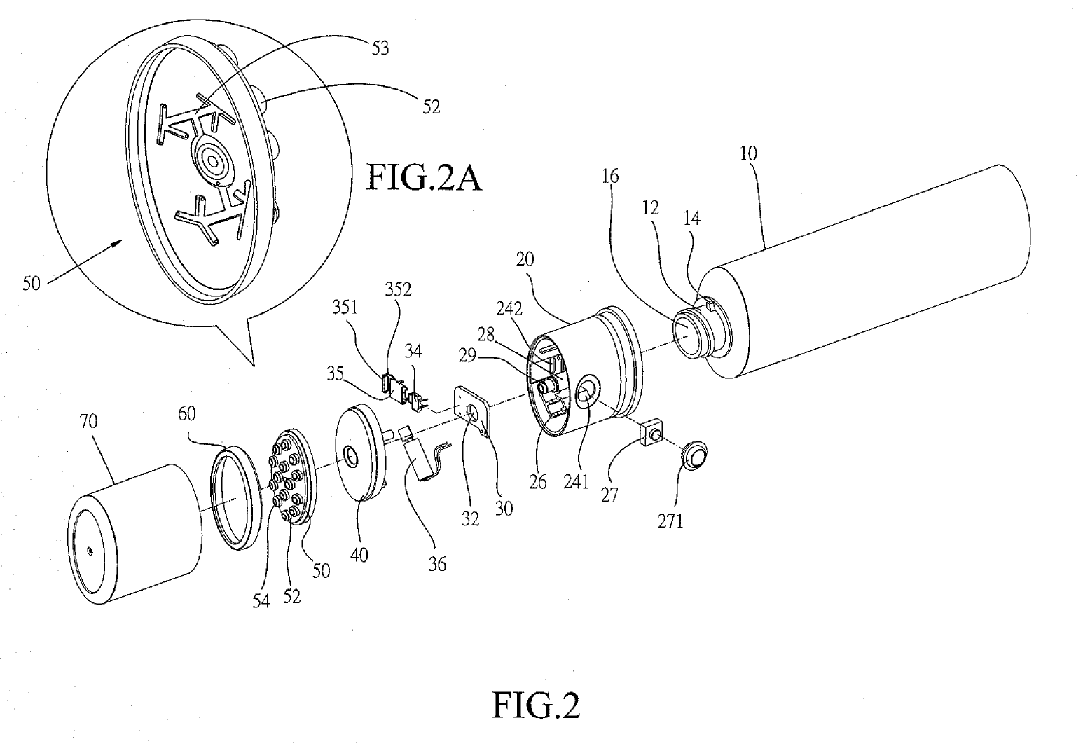

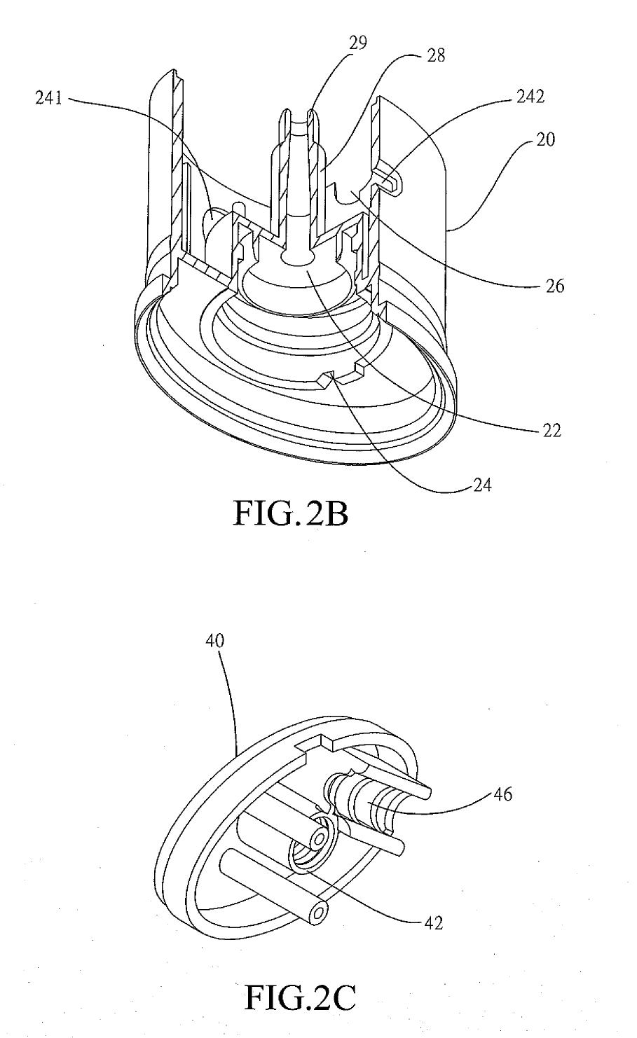

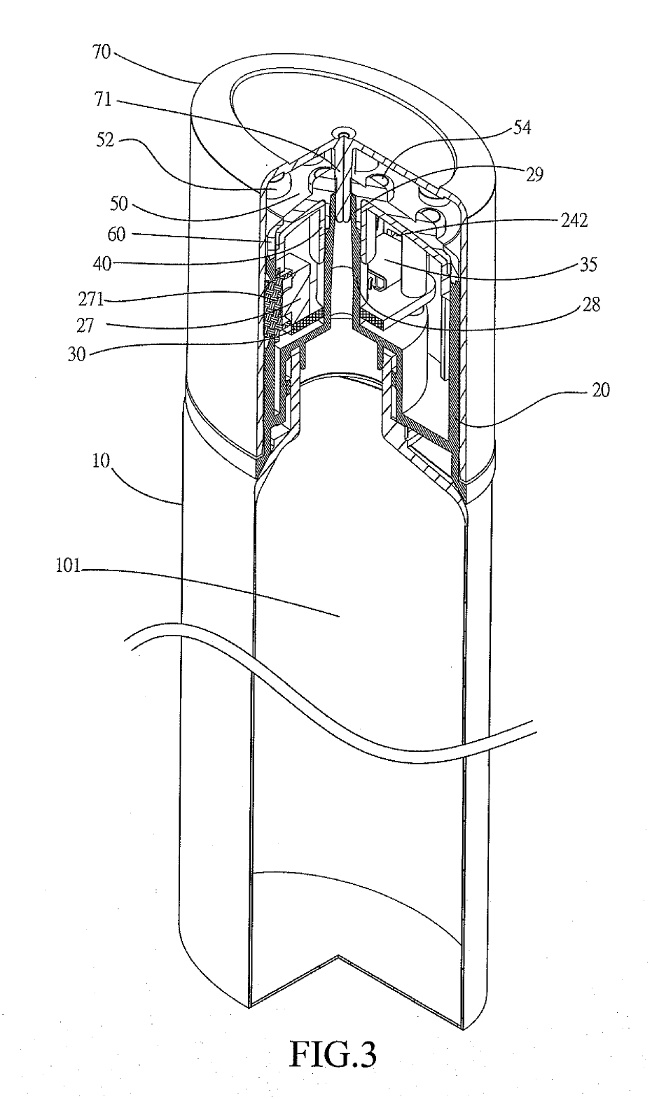

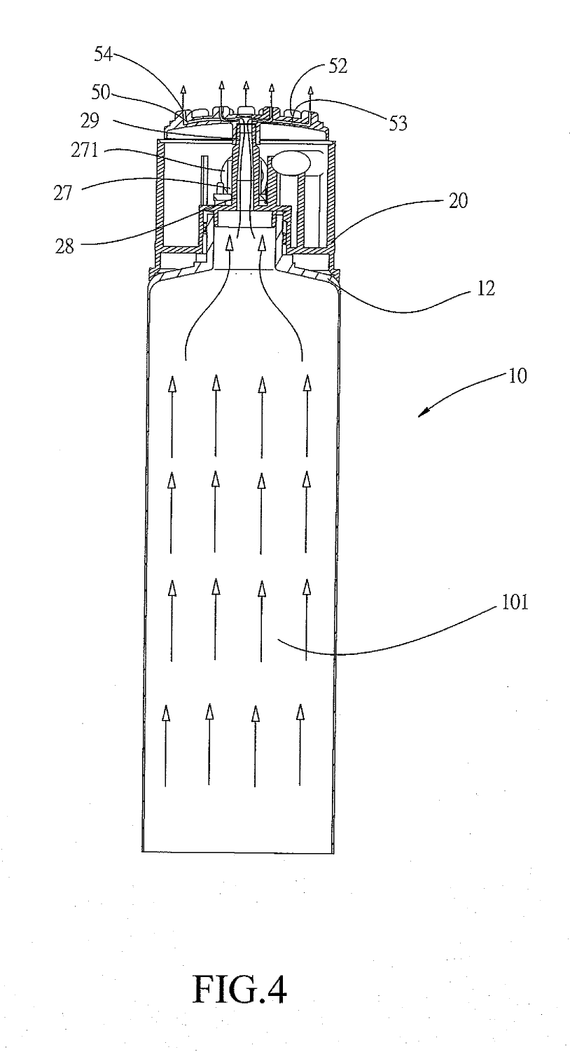

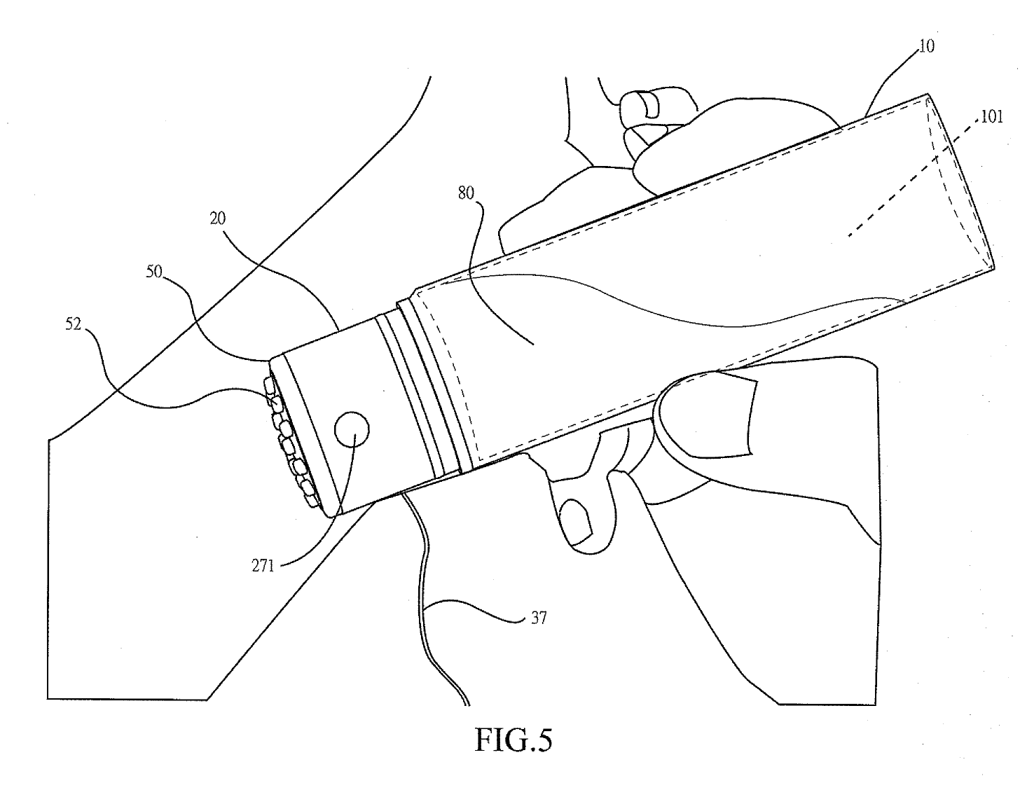

Referring to FIGS. 1 to 5, a massage device having a USB connector in accordance with the invention comprises the following components as discussed in detail below.

A container 10 includes a space 101 for storing fluid 80. The container 10 has a closed bottom end and an open top end. At the open end of the container 10, there are provided a joining neck 12 on an opening 16 communicating with the space 101, and two opposite tabs 14 on the joining neck 12.

A vibration assembly 20 includes an annular groove 22 on an underside, two troughs 24 on the underside, a first hole 241 through a cylindrical surface, a second hole 242 through the cylindrical surface and opposite to the first hole 241, a push button 27 disposed on the first hole 241, a waterproof, plastic cover 271 mounted on the push button 27, an axial channel 28 having a bottom end terminated at the groove 22, a hollow fastening member 29 at a top end of the channel 28, and a recess 26 between the channel 28 and the cylindrical surface.

A circuit board 30 is electrically connected to the push button 27 and includes a through hole 32. A USB connector 34 is electrically connected to the circuit board 30 and a vibration member 36 is electrically connected to the circuit board 30 respectively. A receptacle 35 is provided to receive the USB connector 34 and includes a USB cover 351 and an interconnection member 352 interconnecting the USB cover 351 and the receptacle 35.

A disc shaped discharge seat 40 includes a bossed hole 42 through a center and extending downward to put on the channel 28, and a cavity 46 on a bottom and adjacent to the bossed hole 42. A disc shaped applicator 50 includes a plurality of projections 52 on a top surface, a plurality of hole members 54 each through the projection 52, and a multi-channel member 53 on a bottom surface and communicating with the hole members 54. A fastening ring 60 is securely put on both an edge of the applicator 50 and a top edge of the discharge seat 40 by snapping. A cylindrical cap 70 includes an axial stem 71 extending downward from a bottom.

The groove 22 is put on the joining neck 12 to communicate the channel 28 with the opening 16. The through hole 32 is put on the channel 28. The receptacle 35 is fastened in the second hole 242. The discharge seat 40 is secured to the vibration assembly 20 by putting the bossed hole 42 on the channel 28 after passing the fastening member 29. The applicator 50 is put on the discharge seat 40. The cap 70 is secured to the vibration assembly 20 by inserting the stem 71 into the fastening member 29. The vibration member 36 is disposed in the recess 26. The cavity 46 is secured to the recess 26 to fasten the vibration member 36. The tabs 14 are fastened in the troughs 24 respectively. A power cord 37 is electrically interconnected to the USB connector 34 and an external power source (not shown).

In use, a user may remove the cap 70 to unblock the fastening member 29, hold the container 10 in an inclined position, place the projections 52 on the body part to be massaged, and press the push button 27 to activate the vibration member 26. And in turn, the fluid 80 in the space 101 flows to the projections 52 via the opening 16, the channel 28, the fastening member 29, and the multi-channel member 53. Finally, the fluid 80 flow out of the hole members 54 to apply to the body part. It is envisaged by the invention that the massaging effect on the body part is greatly increased due to the vibration of the vibration member 26.

It is envisaged that the invention has the following advantages and benefits in comparison with the conventional art: In addition to applying fluid to the body part and massaging same by the means of the applicator 50 in one operating mode, in the other operating mode the USB connector 34 is required to connect to an external power source prior to activating the vibration member 36. This can prevent the applicator 50 from being activated by inadvertently pressing the push button 27. The fastening ring 60 is a leak proof device and in cooperation with inserting the stem 71 into the fastening member 29, fluid 80 is prevented from leaving the fastening member 29 in an inoperative position. The USB connector 34 can be connected to a portable power supply or the like prior to use. That is, there is no need of finding a suitable outlet or the like prior to use as experienced by a conventional massage device. Finally, no battery is required and thus problems associated with battery recycling, disposal and pollution are eliminated.

While the invention has been described in terms of preferred embodiments, those skilled in the art will recognize that the invention can be practiced with modifications within the spirit and scope of the appended claims.

What is claimed is:

1. A massage device comprising:
a container having a closed first end and including a space and a joining neck at a second end opposite to the first end, the joining neck communicating with the space and having an opening;
a vibration assembly including an annular groove on an underside, a first hole through a cylindrical surface, a second hole through the cylindrical surface and opposite to the first hole, a push button disposed on the first hole, an axial channel having a first end terminated at the annular groove, and a hollow fastening member at a second end of the annular channel;
a circuit board electrically connected to the push button and including a through hole;
a USB connector electrically connected to the circuit board;
a vibration member electrically connected to the circuit board;
a receptacle configured to receive the USB connector;
a discharge seat including a bossed hole through a center and extending downward to put on the annular channel;
an applicator including a plurality of projections on a first surface, and a plurality of holes, each through one of the projections;
a fastening ring; and
a cap;
wherein the annular groove is put on the joining neck to communicate the axial channel with the opening, the through hole is put on the axial channel, the receptacle is fastened in the second hole, the discharge seat is secured to the vibration assembly with the bossed hole put on the axial channel, the applicator is put on the discharge seat, the fastening ring is securely put on both an edge of the applicator and an edge of the discharge seat, and the cap is secured to the vibration assembly with the stem inserted into the hollow fastening member.

2. The massage device of claim 1, wherein the vibration assembly further comprise a recess adjacent to the axial channel, the discharge seat further comprises a cavity adjacent to the bossed hole, the vibration member is disposed in the recess, and the cavity is secured to the recess to fasten the vibration member.

3. The massage device of claim 1, wherein the container further comprises two opposite tabs on the joining neck, the vibration assembly further comprises two troughs on the underside with the tabs fastened in the troughs respectively.

4. The massage device of claim 1, further comprising a waterproof, plastic cover mounted on the push button.

5. The massage device of claim 1, further comprising a power cord electrically connected to the USB connector.

6. The massage device of claim 1, wherein the space is configured to store fluid which is configured to flow to the projections via the opening, the axial channel, and the fastening member, and further flow out of the hole members.

7. The massage device of claim 1, wherein the receptacle includes a USB cover.

8. The massage device of claim 7, further comprising an interconnection member interconnecting the USB cover and the receptacle.

9. The massage device of claim 7, wherein the applicator further comprises a multi-channel member on a second surface opposite to the first surface, the multi-channel member communicating with the hole members.
